(19) United States
(12) Patent Application Publication
(10) Pub. No.: US 2018/0225110 A1
(43) Pub. Date: Aug. 9, 2018

(54) LEGACY PROGRAM CODE ANALYSIS AND OPTIMIZATION

(71) Applicant: International Business Machines Corporation, Armonk, NY (US)

(72) Inventors: Matthew G. Borlick, Tucson, AZ (US); Lokesh M. Gupta, Tucson, AZ (US); Clint A. Hardy, Tucson, AZ (US); Karl A. Nielsen, Tucson, AZ (US)

(73) Assignee: International Business Machines Corporation, Armonk, NY (US)

(21) Appl. No.: 15/427,241

(22) Filed: Feb. 8, 2017

(51) Int. Cl. G06F 9/44; G06F 11/36

(52) U.S. Cl. CPC G06F 8/72; G06F 11/3664; G06F 11/3688; G06F 11/3612

(57) ABSTRACT

A method for analyzing and optimizing legacy program code is disclosed. In one embodiment, such a method includes logically dividing legacy program code into multiple sections and possibly subsections. The method then instruments each section with a counter that increments a value each time the respective section is executed. The legacy program code is then executed over a specified period of time on a specified number of test systems. The values are then gathered from the counters and analyzed to determine relative importance of the sections. In certain embodiments, this analysis generates a list of sections that are dead. The method then removes, from the legacy program code, sections that are dead. A corresponding system and computer program product are also disclosed.

### BACKGROUND

### Field of the Invention

This invention relates to systems and methods for analyzing and optimizing legacy program code.

### Background of the Invention

Many computing systems contain significant amounts of legacy program code that was developed over the course of many years. This legacy program code may have been altered over the years to add functionality or change existing functionality. In some cases, the legacy program code may have been written for older hardware that is no longer in use. The result is that portions of the legacy program code that were formerly alive and functioning may now be dead (i.e., no longer used and/or reachable). As an example, certain sections of the legacy program code may calculate results that are no longer used in any other computations, resulting in unnecessary processing. In other cases, certain sections of the legacy program code may no longer be reachable by other parts of the legacy program code. The result is that a significant portion of the legacy program code may no longer serve any useful purpose. At worse, the dead code may cause the legacy program code to be overly complex and/or execute irrelevant operations.

In order to simplify and optimize legacy program code, dead or unneeded code may be identified and removed from the legacy program code. However, before removing dead or unneeded code, it may be important to understand how the legacy program code operates, the frequency that portions of the legacy program code operate, and the relative importance of portions of the legacy program code. This may ensure that live or important but infrequently accessed program code is not inadvertently removed from the legacy program code. This may also assist in optimizing and maintaining the legacy program code.

In view of the foregoing, what are needed are systems and methods to better understand how legacy program code operates, the frequency that portions of the legacy program code operate, and the relative importance of portions of the legacy program code. Ideally, this will assist in removing dead or unneeded code, as well as maintaining and optimizing the legacy program code.

### SUMMARY

The invention has been developed in response to the present state of the art and, in particular, in response to the problems and needs in the art that have not yet been fully solved by currently available systems and methods. Accordingly, systems and methods in accordance with the invention have been developed to analyze and optimize legacy program code. The features and advantages of the invention will become more fully apparent from the following description and appended claims, or may be learned by practice of the invention as set forth hereinafter.

Consistent with the foregoing, a method for analyzing and optimizing legacy program code is disclosed. In one embodiment, such a method includes logically dividing legacy program code into multiple sections and possibly subsections. The method then instruments each section with a counter that increments a value each time the respective section is executed. The legacy program code is then executed over a specified period of time on a specified number of test systems. The values are then gathered from the counters and analyzed to determine relative importance of the sections. In certain embodiments, this analysis generates a list of sections that are dead. The method then removes, from the legacy program code, sections that are dead.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system that may be used to execute legacy program code and/or a method in accordance with the invention;

FIG. 2 shows a system and associated modules that may be used to implement a method for analyzing and optimizing legacy program code;

FIG. 3 shows legacy program code divided into multiple sections, where each section is instrumented with a counter;

FIG. 4 shows the legacy program code of FIG. 3 further divided into sub-sections, where each sub-section is instrumented with a counter; and

FIG. 5 shows the legacy program code of FIG. 4 with dead sections and dead sub-sections highlighted.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

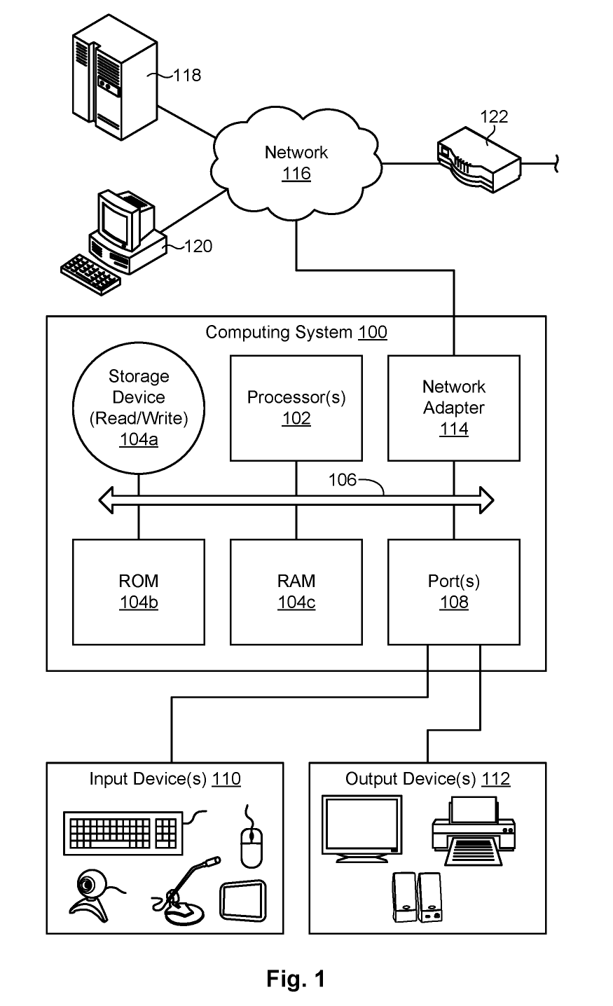

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, a storage controller, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

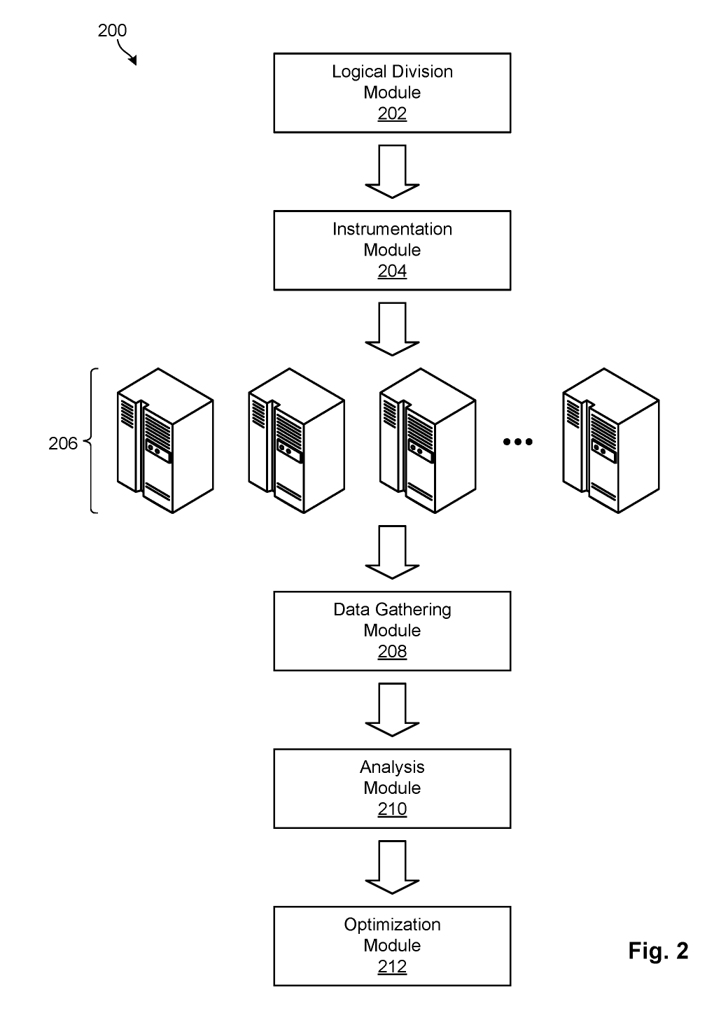

Referring to FIG. 2, as previously mentioned, many computing systems 100 contain significant amounts of legacy program code that was developed over the course of many years. This legacy program code may have been altered over the years to add functionality or change existing functionality. In some cases, the legacy program code may have been written for older hardware that is no longer in use or subject to infrequent use. The result is that portions of the legacy program code that were formerly alive and functioning may now be dead (i.e., no longer used and/or reachable). As an example, certain sections of the legacy program code may calculate results that are no longer used in any other computations, resulting in unnecessary processing. In other cases, certain sections of the legacy program code may no longer be reachable by other parts of the legacy program code. The result is that a significant portion of the legacy program code may no longer serve any useful purpose. At worse, the dead code may cause the legacy program code to be overly complex and/or execute irrelevant operations.

In order to simplify and optimize legacy program code, dead or unneeded code may be identified and removed from the legacy program code. However, before removing dead or unneeded code, it may be important to understand how the legacy program code operates, the frequency that portions (e.g., code sections, modules, routines, subroutines, algorithms, etc.) of the legacy program code operate, and/or the relative importance of portions of the legacy program code. This may ensure that live or important but infrequently accessed program code is not inadvertently removed from the legacy program code. This may also assist in optimizing and maintaining the parts of the legacy program code that are alive.

FIG. 2 is a high-level block diagram showing one embodiment of a system 200 for analyzing and optimizing legacy program code. As shown, the system 200 includes various modules to perform different features and functions. These modules may be implemented in hardware, software, firmware, or combinations thereof. As shown, the modules include a logical division module 202, instrumentation module 204, data gathering module 208, analysis module 210, and optimization module 212. These modules are presented by way of example and not limitation. The system 200 may include more or fewer modules than those illustrated, or the functionality of the modules may be combined or split into additional modules as needed.

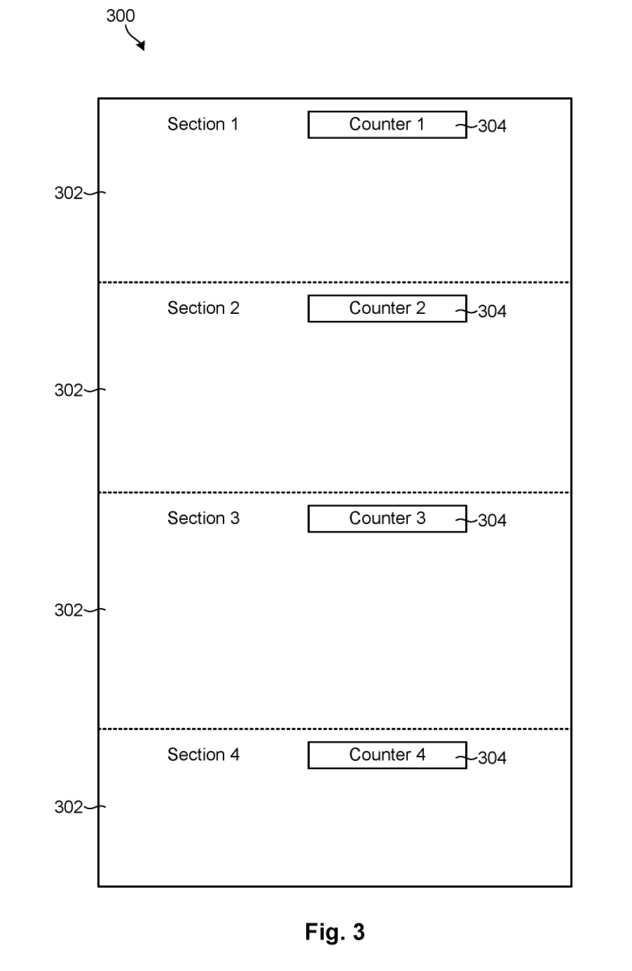

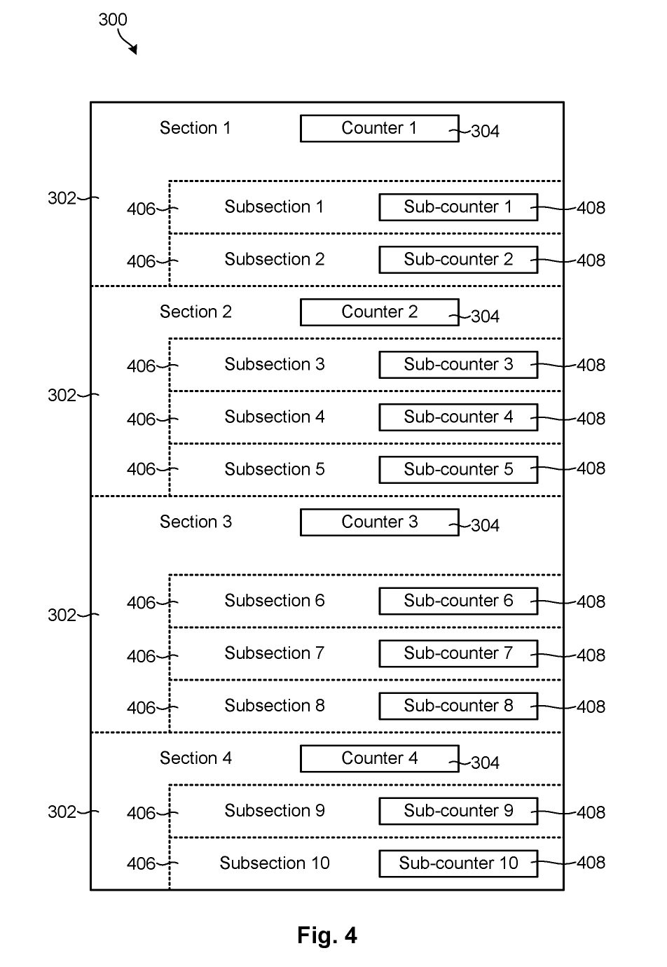

In order to understand relative importance of various sections of legacy program code as well as find potentially dead sections within the legacy program code, the logical division module 202 may logically divide the legacy program code into multiple sections. In certain embodiments, these sections may correspond to modules, functions, routines, subroutines, algorithms, classes, objects, or other divisions within the legacy program code. FIG. 3 shows a high-level example of legacy program code 300 divided into multiple sections 302. In certain embodiments, these sections 302 may be further divided into subsections 406, as shown in FIG. 4. For example, assuming a section 302 corresponds to an “if-then-else statement,” each subsection 406 may correspond to a different path or branch within the “if-then-else statement.” Additional levels of subsections are possible and within the scope of the invention. For the purpose of the specification and claims, the term “sections” may include sections 302 and well as subsections 406, sub-subsections, sub-sub-subsections, etc.

Once the logical division module 202 logically divides the legacy program code 300 into sections 302 and possibly subsections 406, the instrumentation module 204 may instrument these sections 302 and subsections 406 with counters 304 and sub-counters 408. Each of these counters 304, 408 may increment a value each time the corresponding section 302 or subsection 406 is executed. In certain embodiments, the counters 304, 408 may be introduced into the legacy program code 300 in the form of new program code. In such embodiments, the count values may be maintained within the legacy program code 300. In other embodiments, each time a particular section 302 or subsection 406 is executed, a call may be made to an external system which keeps track of the count values for each section 302 and subsection 406. Thus, different techniques may be used to track how many times a particular section 302 or subsection 406 is executed.

Once the legacy program code 300 is instrumented, the legacy program code 300 may be executed on one or more test systems 206 for a specified period of time (also referred to as a “test cycle”). The test systems 206 may be mainframe computers, storage controllers, workstations, desktop computers, laptops, mobile devices, or the like. The test systems 206 may be actual production computing systems 100 operating in the field or computing systems 100 used exclusively for testing purposes. In certain embodiments, the test systems 206 may operate in different environments that may use the legacy program code 300 differently or utilize different sections 302, 406 of the legacy program code 300 differently or with different frequency. In certain cases, more test systems 206 may produce better results as to how the legacy program code 300 is being used and the relative importance of sections 302, 406 within the legacy program code 300.

While the test systems 206 are operating and/or after the test systems 206 have operated for a specified period of time, the data gathering module 208 may gather the count values. In certain embodiments, the count values may be sent from the test systems 206 to the data gathering module 208 (which may be implemented on a different computing system 100) using email, a “call home” function, or the like. In other embodiments, the count values may be maintained in a database which may be sent to the data gathering module 208.

The analysis module 210 may then analyze the count values to determine the relative importance (e.g., frequency of operation) of each of the sections 302 and subsections 406. In certain embodiments, the analysis module 210 may generate a list of sections 302 or subsections 406 that are dead (having count values of zero). Alternatively, or in addition, the analysis module 210 may generate a list of sections 302 and/or subsections 406 and their importance or frequency of use based on the count values.

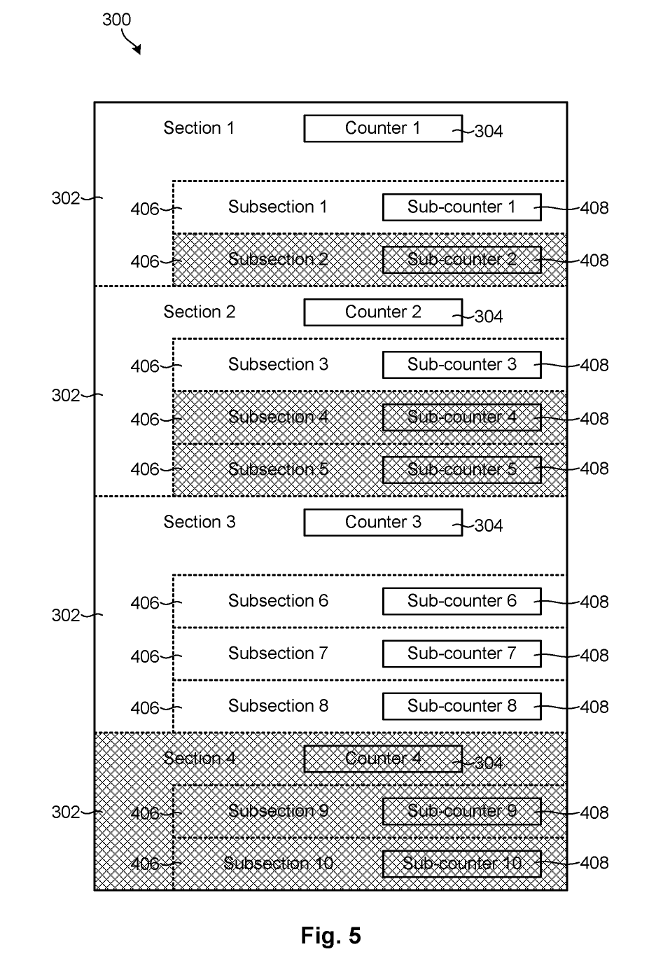

Based on the analysis performed by the analysis module 210, the optimization module 212 may optimize the legacy program code 300. In certain cases, this may include removing, from the legacy program code 300, sections 302 or subsections 406 that are dead or have count values that fall below a selected threshold. For example, referring to FIG. 5, assume that after executing the legacy program code 300 for a selected amount of time, count values for Section 4 and Subsections, 2, 4, 5, 9, and 10 (as shown by the highlighting in FIG. 5) are zero. The optimization module 212 may remove (or provide a recommendation or instructions to an administrator to remove) these sections 302 and subsections 406 from the legacy program code 300 to optimize it and make it execute more efficiently.

In other cases, the optimization module 212 may be used to optimize sections 302 or subsections 406 of the legacy program code 300 that are important or used with some specified frequency. For example, sections 302 or subsections 406 or program code that are used frequently may be tagged to be re-written, cleaned up, or compiled in a way that that makes them operate more efficiently. In other cases, hardware or software may be optimized to run more efficiently with frequently-used sections 302 or subsections 406. In this way, frequently-used sections 302 or subsections 406 may be maintained and optimized in the legacy program code 300.

In yet other cases, the optimization module 212 may optimize the legacy program code 300 by optimizing various parameters or default values within the legacy program code 300. For example, consider legacy program code 300 that runs on a storage system controller (such as the IBM DS8000™ enterprise storage system controller). This legacy program code 300 may execute task control blocks (TCBs) to demote data from the storage controller cache. The number of task control blocks that are used to demote data from the cache may vary in different situations. For example, the legacy program code 300 may run between one and sixteen TCBs to demote data from the cache. In order to understand how the TCBs are used, counters 304, 408 may be established for the TCBs. If, after running the legacy program code 300 for a test cycle, it is observed that the legacy program code 300 most often uses four TCBs to demote data from the cache, this may indicate that the legacy program code 300 runs most efficiently with four TCBs. The optimization module 212 may consequently set four (instead of an arbitrary number) as the default number of TCBs that are used when executing the legacy program code 300.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for analyzing and optimizing legacy program code, the method comprising:
logically dividing legacy program code into a plurality of sections;
instrumenting each section with a counter that increments a value each time the respective section is executed;
executing, on at least one test system, the legacy program code over a specified period of time;
gathering the values from the counters;
analyzing the values to determine a relative importance of the sections; and
identifying for removal, from the legacy program code, sections having a counter value of zero.

2. The method of claim 1, wherein analyzing the values to determine a relative importance of the sections comprises generating a list of sections that are dead.

3. The method of claim 1, wherein the at least one test system comprises at least one of a production system and a dedicated test system.

4. The method of claim 1, wherein the counters are maintained on the at least one test system.

5. The method of claim 1, wherein the counters are maintained on a system external to the at least one test system.

6. The method of claim 1, further comprising optimizing the legacy program code based on the values from the counters, wherein optimizing comprises setting a default value for the legacy program code.

7. The method of claim 1, further comprising optimizing the legacy program code based on the values from the counters, wherein optimizing comprises cleaning up sections of the legacy program code having counter values that meet a selected threshold.

8. A computer program product to analyze and optimize legacy program code, the computer program product comprising a computer-readable storage medium having computer-usable program code embodied therein, the computer-usable program code configured to perform the following when executed by at least one processor:
logically divide legacy program code into a plurality of sections;
instrument each section with a counter that increments a value each time the respective section is executed;
execute, on at least one test system, the legacy program code over a specified period of time;
gather the values from the counters;
analyze the values to determine a relative importance of the sections; and
identify for removal, from the legacy program code, sections having a counter value of zero.

9. The computer program product of claim 8, wherein analyzing the values to determine a relative importance of the sections comprises generating a list of sections that are dead.

10. The computer program product of claim 8, wherein the at least one test system comprises at least one of a production system and a dedicated test system.

11. The computer program product of claim 8, wherein the counters are maintained on the at least one test system.

12. The computer program product of claim 10, wherein the counters are maintained on a system external to the at least one test system.

13. The computer program product of claim 8, wherein the computer-usable program code is further configured to optimize the legacy program code based on the values from the counters, wherein optimizing comprises setting a default value for the legacy program code.

14. The computer program product of claim 8, wherein the computer-usable program code is further configured to optimize the legacy program code based on the values from the counters, wherein optimizing comprises cleaning up sections of the legacy program code having counter values that meet a selected threshold.

15. A system to analyze and optimize legacy program code, the system comprising:
at least one processor;
at least one memory device operably coupled to the at least one processor and storing instructions for execution on the at least one processor, the instructions causing the at least one processor to:
logically divide legacy program code into a plurality of sections;
instrument each section with a counter that increments a value each time the respective section is executed;
execute, on at least one test system, the legacy program code over a specified period of time;
gather the values from the counters;
analyze the values to determine a relative importance of the sections; and
identify for removal, from the legacy program code, sections having a counter value of zero.

16. The system of claim 15, wherein analyzing the values to determine a relative importance of the sections comprises generating a list of sections that are dead.

17. The system of claim 15, wherein the at least one test system comprises at least one of a production system and a dedicated test system.

18. The system of claim 15, wherein the counters are maintained on the at least one test system.

19. The system of claim 15, wherein the counters are maintained on a system external to the at least one test system.

20. The system of claim 15, wherein the instructions further cause the at least one processor to optimize the legacy program code based on the values from the counters.
